(19) United States
(12) Patent Application Publication
(10) Pub. No.: US 2010/0289256 A1
(43) Pub. Date: Nov. 18, 2010

(54) Pipe insertion indicator and method of use

(76) Inventor: Dennis Shumard, Katy, TX (US)

Correspondence Address: George R. Schultz;Schultz & Associates, P.C., One Lincoln Centre, 5400 LBJ Freeway, Suite 1200, Dallas, TX, 75240, US

(21) Appl. No.: 12/798,641

(22) Filed: Apr. 8, 2010

Related U.S. Application Data
(60) Provisional application No. 61/216,469, filed on May 18, 2009.

(51) Int. Cl. F16L 55/00; F16L 35/00

(52) U.S. Cl. 285/18; 285/93; 285/331

(57) ABSTRACT

An insertion indicator is provided for a bell and spigot pipe connection system, including a stop ring positioned on the spigot pipe. An indicator is provided adjacent the stop ring and the bell pipe for indicating a proper insertion depth. A break away tab is provided as an insertion indicator which shears away upon an over insertion condition. A flexible insertion indicator tab is provided. Further, a flexible annular ring is provided to indicate insertion depth. An insertion indicator is further provided which includes an annular stop ring fixed to the spigot pipe and a bell stop ring slidingly engaging the spigot pipe, separated by resilient member. Compression deforms the resilient member which responds by moving the pipes into an optimal position. An insertion indicator is also provided which includes a first semi-circular stop member and a second semi-circular stop member which are angularly deflected creating an indication of proper insertion depth.

### CROSS-REFERENCE TO RELATED APPLICATIONS

This application claims priority benefit from U.S. Provisional Patent Application Ser. No. 61/216,469 entitled “Pipe Insertion Indicator and Method of Use” filed on May 18, 2009.

### FIELD OF THE INVENTION

This disclosure relates generally to methods of joining large underground pipes having bell and spigot joining systems.

### BACKGROUND

In order to assemble long runs of large diameter buried pipe, multiple sections must be assembled. One system of joining pipe sections is a “bell and spigot” system. In joining the sections, the spigot of each successive pipe is inserted into the bell of the previous pipe until an optimal insertion depth is achieved. An optimal insertion position provides clearance between the end of the spigot and the back of the bell sufficient to allow joint pressurization, thermal expansion and angular joint deflection. Over-insertion of the spigot, so that the end of the spigot wedges against the back of the bell, induces stress that can lead to premature pipe failure.

Over-insertion routinely occurs in the field. Even if care is taken to assemble a joint properly, the force used to assemble successive joints may cause over insertion in the previous joints. To complicate matters, over insertion is typically not discovered until the entire run of pipe has been buried. Removal and replacement of an incorrectly assembled joint is thus expensive, difficult and time consuming.

Various unsatisfactory solutions to the problem of over-insertion have been attempted in the prior art.

U.S. Pat. No. 2,953,398 to Haugen teaches a spigot inserted into a bell, where the interior of the bell has a shoulder against which the spigot stops. Haugen also teaches a gasket that is compressed by the spigot as it is inserted, holding the spigot in place. Haugen does nothing to prevent damage of the spigot against the shoulder stop of the bell. Further, the shoulder stop of Haugen acts to limit the motion of the spigot relative to the bell, rather than allowing motion to compensate for movement or thermal expansion.

U.S. Pat. No. 4,127,290 to Mutschlechner teaches a clamping collar positioned around a spigot. The clamping collar locks with a flange located on the bell. A locking member is fastened between the clamping collar and flange. The two pipes are thus fixed relative to each other. However, fixing the pipes prevents movement required to compensate for soil movement and thermal expansion.

A need exists for a piping connection system that provides a clear indication of over-insertion of a spigot into a bell. Further, a need exists for a piping connection system that maintains a spigot and a bell at an optimum insertion position and angle. A need also exists for a piping connection system that guides proper insertion to avoid joint separation due to joint pressurization, soil movement and thermal expansion.

### SUMMARY OF THE INVENTION

This disclosure provides for an insertion indicator for a bell and spigot pipe connection system including a stop ring positioned on the spigot pipe. An indicator is provided adjacent the stop ring and the bell pipe for indicating a proper insertion depth. The indicator can include, among other things, a breakaway tab connected to the stop ring which contacts the bell pipe upon a proper insertion depth and shears away from the stop ring upon an over insertion depth. A plurality of breakaway tabs provides an indicator of an angular displacement of the bell pipe relative to the spigot pipe. In this configuration one or more break away tabs may shear away from the indicator leaving one or more break away tabs in place. The indicator may also be a flexible annular ring made of elastomeric or polymeric material which deforms radially on an over insertion condition.

This disclosure also provides for an insertion indicator which includes an annular stop ring fixed to the spigot pipe, a bell stop ring slidingly engaging the spigot pipe and positioned adjacent to bell pipe and a resilient member connecting the annular stop ring and the bell stop ring. An over insertion condition drives the bell pipe into the bell stop ring thereby compressing the resilient member until it engages the annular stop ring. When the compression force is removed from the bell pipe the resilient member decompresses and moves the bell pipe away from the spigot pipe to a position of proper insertion. The resilient member in one embodiment is a series of metallic compression springs and in other embodiments can be an elastomeric or polymeric ring.

This disclosure also provides for an insertion indicator comprised of a spigot flange and a bell flange adjacent the spigot pipe and bell pipe, respectively. A plurality of compression bolts is spaced radially around the spigot flange and bell flange, connecting the two. A pipe clamp stop ring surrounds the spigot pipe and is positioned adjacent the spigot flange and the bell pipe. Advancing the compression bolts moves the spigot pipe into the bell pipe. The pipe clamp stop ring halts the advance of the bell pipe indicating a optimum insertion condition.

This disclosure further provides for an insertion indicator comprised of a first semi-circular stop member and a second semi-circular stop member surrounding the spigot pipe and connected at pair of connecting flanges. As the bell pipe is advanced toward the spigot pipe it engages the first and second semi-circular stop member and displaces them creating an angular gap between the connecting flanges which serves as an indication of proper insertion depth. In another embodiment a series of elastomeric washers is provided between the connecting flanges and between the bolts securing the connecting flanges and providing a further indication of insertion depth. Sighting portals may be include on either or both of the semi-circular stop members so that a line on the spigot may be seen during use and used to judge proper insertion depth.

The elastomeric stop ring can also connected to the spigot pipe with the use of a band clamp resident in an annular channel. Over insertion deforms the stop ring providing indication of over insertion depth. Sighting portals may also be provided in the elastomeric stop ring for viewing markings on the spigot pipe during use.

This disclosure also provides for an insertion indicator including a spigot flange slidingly engaged with the spigot pipe and having a first angled annular channel adjacent the spigot pipe. A bell flange is also provided, slidingly engaged with the bell pipe adjacent the bell flare. A plurality of compression bolts connects the spigot flange and the bell flange. A stop ring is fixed to the spigot pipe having first and second angled annular surfaces. This embodiment also provides an annular spacing stop having an angled annular channel adjacent the stop ring. A compression spring or other resilient member connects the annular spring stop member to the bell pipe. As the compression bolts are advanced the resilient member is compressed and the angular channel of the annular spring stop member engages an annular surface of the stop ring. Similarly, the angled annular channel of the spigot flange engages the other angled surface of the stop ring. When fully compressed the annular stop ring member, the stop ring and the annular spring stop member are lockingly engaged to prevent further advancement of the bell pipe onto the spigot pipe. An optimum insertion condition is indicated by the distance between the bell pipe and the spring stop.

This disclosure further provides for a pipe clamp stop comprised of a circular outer ring having an annular beveled surface and annular reverse stop surface in a circular inner ring having a mating annular beveled surface and a mating annular reverse stop surface engaging the reverse stop surface.

This disclosure further provides for a pipe clamp stop for a bell pipe and spigot connection system comprised of two semi-circular stop members including annular serrations adjacent the spigot pipe. Upon connection the annular serrations embed themselves in the surface of the spigot pipe preventing movement of the pipe clamp stop.

### BRIEF DESCRIPTION OF THE DRAWINGS

Some of the features and benefits of the present disclosure having been stated, others will become apparent when taken in conjunction with the accompanying drawings, in which:

FIG. 1A is an axial view of a preferred embodiment.

FIG. 1B is a partial cross section view of a preferred embodiment.

FIG. 2A is an axial view of a preferred embodiment.

FIG. 2B is a partial cross-section view of a preferred embodiment.

FIG. 3A is an isometric view of a preferred embodiment.

FIG. 3B is an axial view of a preferred embodiment.

FIG. 3C is a cross-section view of a preferred embodiment, prior to insertion.

FIG. 3D is a partial cross-section view of a preferred embodiment at an optimal insertion position.

FIG. 3E is a partial cross-section view of a preferred embodiment at an over insertion position at insertion.

FIG. 3F is a partial cross-section detail view of a preferred embodiment in use.

FIG. 4A is an isometric view of an alternate embodiment.

FIG. 4B is an axial view of an alternate embodiment.

FIG. 4C is a cross-section view of an alternate embodiment, prior to insertion.

FIG. 4D is a partial cross-section view of an alternate embodiment at an optimal insertion position.

FIG. 4E is a partial cross-section view of an alternate embodiment in use.

FIG. 5A is an isometric view of an alternate embodiment.

FIG. 5B is an axial view of an alternate embodiment.

FIG. 5C is a partial cross-section view of an alternate embodiment in use.

FIG. 6A is an isometric view of an alternate embodiment.

FIG. 6B is an axial view of an alternate embodiment.

FIG. 6C is a partial cross-sectional view of an alternate embodiment prior to insertion.

FIG. 6D is a partial cross-section view of an alternate embodiment at an optimal insertion position.

FIG. 6E is a partial cross-section view of an alternate embodiment at an over insertion position.

FIG. 7A is an isometric view of an alternate embodiment.

FIG. 7B is an axial view of an alternate embodiment.

FIG. 7C is a partial cross-section view of an alternate embodiment at an optimal insertion position.

FIG. 7D is a partial cross-section view of an alternate embodiment at an over insertion position.

FIG. 8A is an isometric view of an alternate embodiment.

FIG. 8B is an axial view of an alternate embodiment.

FIG. 8C is a partial cross-section view of an alternate embodiment, prior to insertion.

FIG. 8D is a partial cross-section view of an alternate embodiment at an optimal insertion position.

FIG. 8E is a partial cross-section view of an alternate embodiment at an over insertion position.

FIG. 9A is an isometric view of an alternate embodiment.

FIG. 9B is a partial cross-section view of an alternate embodiment in use.

FIG. 9C is a partial cross-section view of an alternate embodiment at an optimal insertion position.

FIG. 10A is an isometric view of an alternate embodiment.

FIG. 10B is a cross-section view of an alternate embodiment at an optimal insertion position.

FIG. 10C is a cross-section view of an alternate embodiment at an over insertion position.

FIG. 10D is a cross-section view of an alternate embodiment at an optimal insertion position.

FIG. 10E is a cross-section view of an alternate embodiment at an over insertion position.

FIG. 11A is an isometric view of an alternate embodiment.

FIG. 11B is a partial cross-section view of an alternate embodiment.

FIG. 11C is an isometric view of an alternate embodiment.

FIG. 11D is a partial cross-section view of an alternate embodiment.

FIG. 12 is a side view of an alternate embodiment in an optimal insertion position.

FIG. 13A is an isometric view of an alternate embodiment.

FIG. 13B is a partial cross-section view of an alternate embodiment in use.

FIG. 13C is a partial cross-section view of an alternate embodiment at an optimal insertion position.

FIG. 13D is a partial cross-section view of an alternate embodiment at an over insertion position.

### DETAILED DESCRIPTION OF THE PREFERRED EMBODIMENTS

The present invention is described with reference to the drawings as shown. The invention may take different forms and should not be construed as limited to the embodiments described. Like numbers refer to like elements throughout.

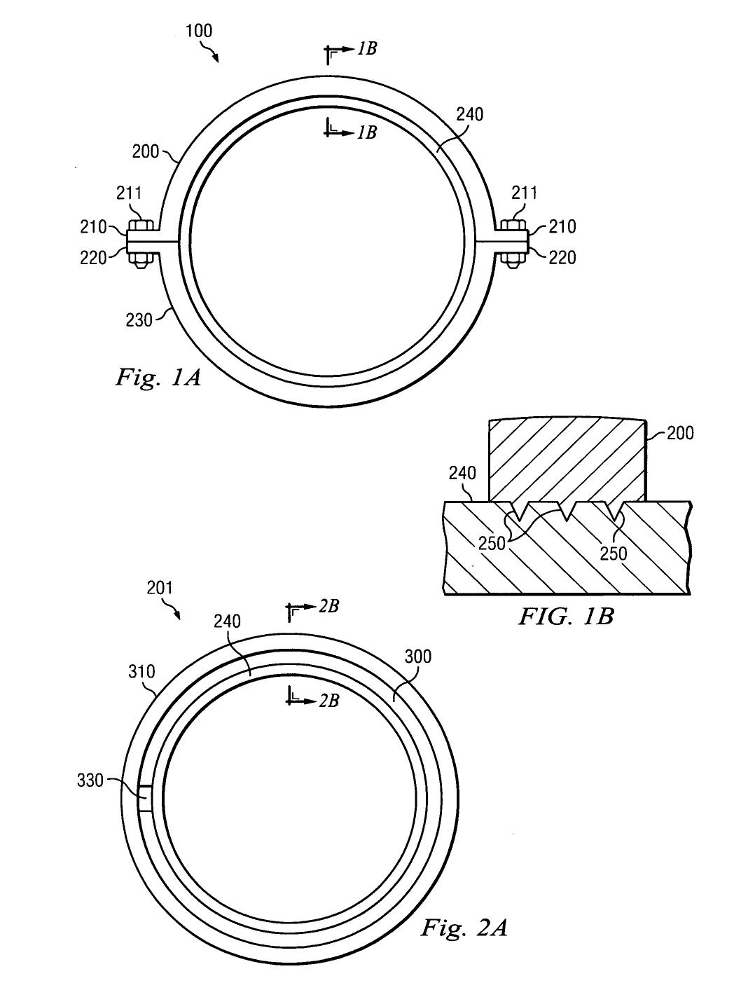

FIGS. 1A and 1B show a preferred embodiment of pipe clamp 100. Upper section 200 and lower section 230 each have flanges 210 and 220 to secure the pipe clamp around a spigot pipe 240 by use of bolts 211. As shown in FIG. 1B, the pipe clamp is includes serrations 250 that deform the outer surface of spigot pipe 240.

Upper section 200 and lower section 230 are positioned around a spigot and bolts 211 are placed through flanges 210 and 220 respectively. As the bolts are tightened serrations 250 embed themselves in the outer surface of spigot pipe 240. As the spigot pipe is inserted into the bell (not shown) the distance between the bell and the pipe clamp forms an indicator of an optimal insertion position. An over insertion position is prevented by contact of the bell with the pipe clamp.

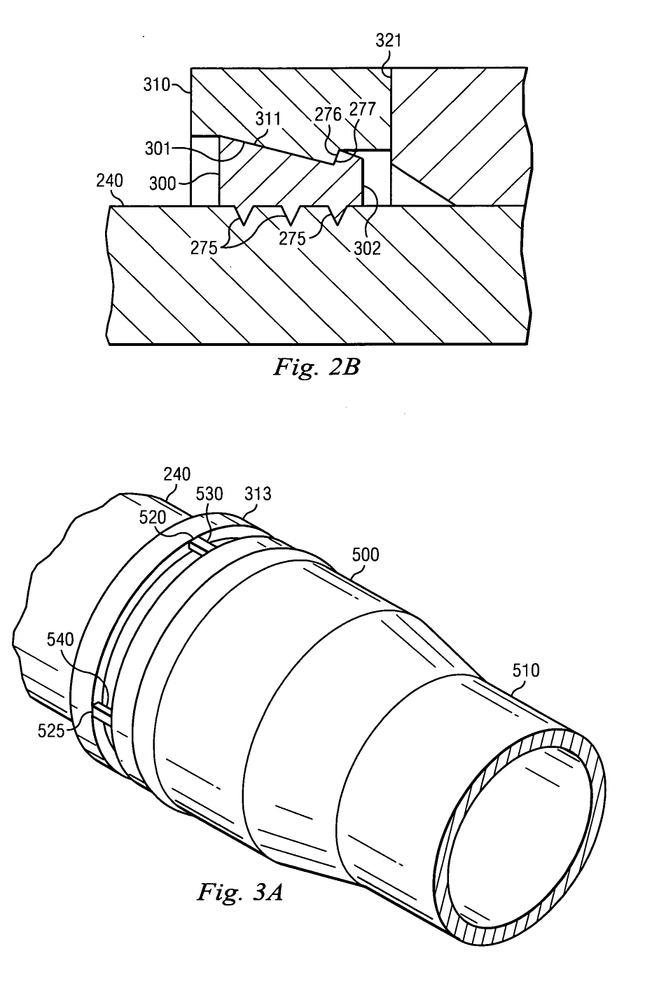

FIGS. 2A and 2B show a preferred embodiment of pipe clamp 201. Pipe clamp 201 consists of inner ring 300 and outer ring 310. The outer ring includes beveled surface 311. Outer ring 310 also includes reverse stop surface 276. The inner ring includes a mating beveled surface 301. Inner ring 300 includes mating reverse stop surface 277. Inner ring 300 is provided with gap 330 and serrations 275 adjacent to and embedded in spigot pipe 240.

In use, inner ring 300 is positioned on spigot by expanding gap 330. When in place on the spigot pipe, outer ring 310 is positioned around inner ring 300 by engaging beveled surface 311 and mating beveled surface 301. The spigot pipe is then inserted into the bell pipe and bell front lip 321 is brought into contact with outer ring 310, thereby forming an indication of optimal insertion. Axial pressure from spigot pipe 240 toward bell front lip 321 results in a sliding movement between the beveled surface and the mating beveled surface. The diameter of inner ring 300 is thereby reduced, increasing friction between inner ring 300 and spigot pipe 240 and embedding serrations 275 in spigot pipe 240. Movement of spigot pipe 240 is stopped when bell front lip 321 contacts surface 302 of inner ring 300. Gap 330 allows for compression of inner ring 300. Reverse stop surface 276 engages mating reverse stop surface 277 thereby preventing outer ring 310 from disengaging with inner ring 300.

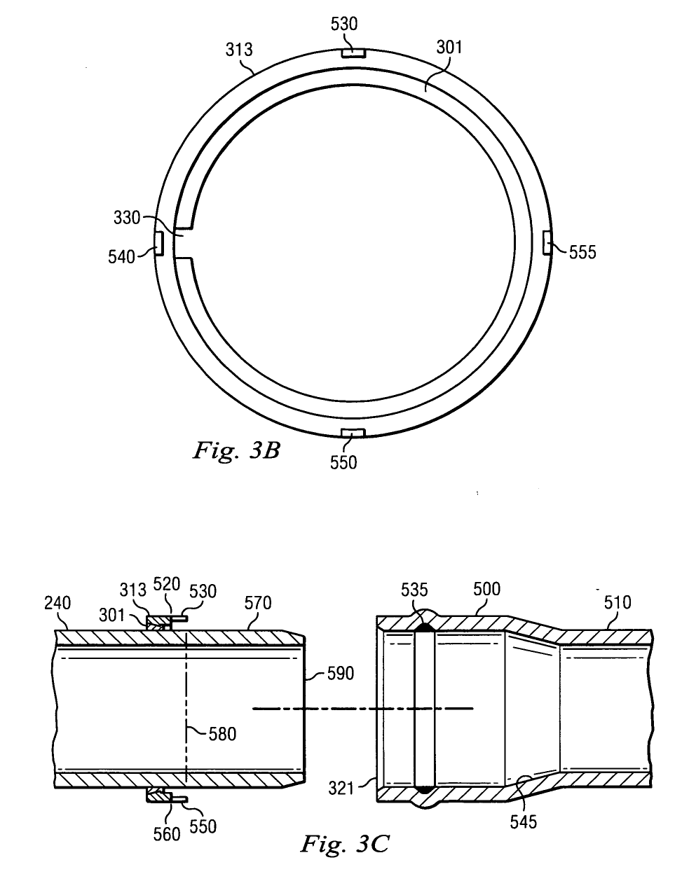

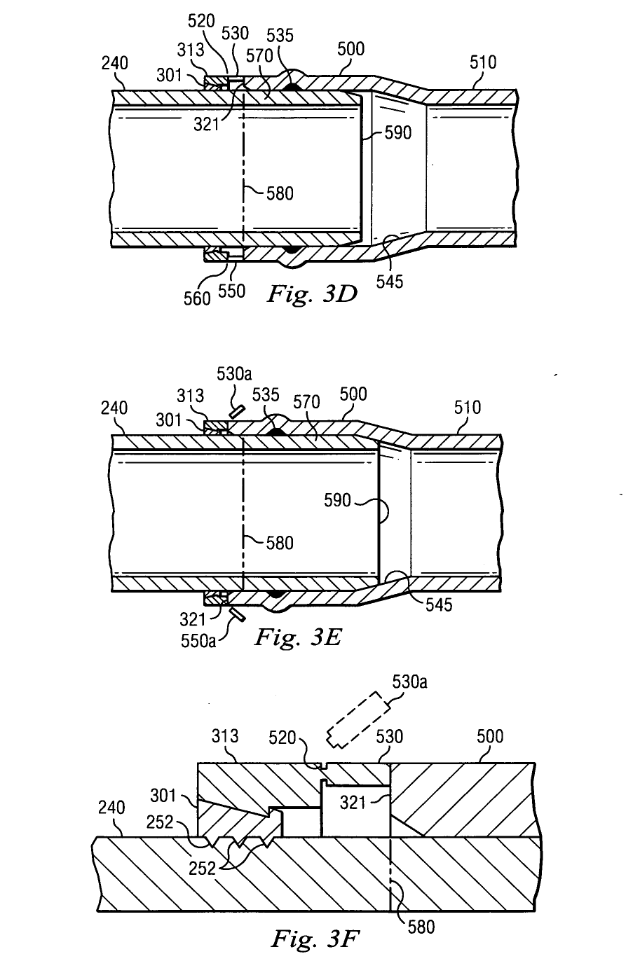

FIGS. 3A through 3F show various views of a preferred embodiment. Bell 500 on pipe 510 includes bell back 545, bell front lip 321, and seal 535. Spigot 570 on spigot pipe 240 includes spigot end 590 and insertion mark 580 appearing on the outer wall surface. Breakaway insertion indicators 530, 540, 550 and 555 are attached to outer ring 313. The breakaway insertion indicators include scoring lines which circumscribe the base of each indicator. Examples are shown at 520, 525, and 560 for breakaway insertion indicators 530, 540, and 550, respectively. Each scoring line forms a reduced perimeter cross section relative to the indicator. The reduced perimeter cross section forms a stress riser. Bending of the indicator in any direction causes a crack to nucleate at the stress riser and propagate across the cross section of the indicator causing the indicator to shear away from the outer ring.

In the preferred embodiment, the breakaway insertion indicators are constructed of an acrylic plastic such as poly (methylmethacrylate). Each indicator preferably includes an iridescent dye aiding in visual location. The iridescent dye is also capable of fluorescing under ultraviolet light aiding in location during inclement or low light conditions with the aid of a fluorescent lamp. In another preferred embodiment the acrylic plastic is polarized allowing detection of induced stress under normal light with the aid of a polarizing filter. Attachment is accomplished by, way of, solvent welding or application of a suitable epoxy adhesive. In other embodiments the break away insertion indicators are constructed of a brittle cast iron or metal alloy. Alternatively, the break away insertion indicators are integrally formed with outer ring 313.

FIG. 3B shows an axial view. A plurality of breakaway insertion indicators 530, 550, 540 and 555 are shown. The plurality is equally radially spaced about the perimeter of the stop ring. Other embodiments may include a greater or lesser number of breakaway indicators.

FIG. 3C is a cross-section view of the preferred embodiment in position on spigot 570 and bell 500 prior to insertion. Coaxial alignment of the pipes in indicated.

FIG. 3D shows the preferred embodiment at an optimal insertion position. In its optimal insertion position, bell front lip 321 is in contact with each of breakaway insertion indicators 530 and 550. Also bell front lip 321 and insertion mark 580 are aligned around the circumference of the spigot pipe. In an optimal position, a clearance is provided between spigot end 590 and bell back 545. The clearance allows movement between bell 500 and spigot 570 to compensate for pipe pressurization, soil movement and thermal expansion.

FIG. 3E shows a cross-sectional view of a bell and spigot at an over insertion position. FIG. 3F shows a partial cross-section detail view of the preferred embodiment at an over insertion condition. Breakaway insertion indicators 530a and 550a a have sheared away, indicating over insertion of spigot 570 into bell 500. Bell front lip 321 is in contact with outer ring 313 which prevents further movement. Alternatively, if some but not all of the insertion indicators shear away, an indication may be derived that spigot 570 was inserted into bell 500 at an undesirable angle.

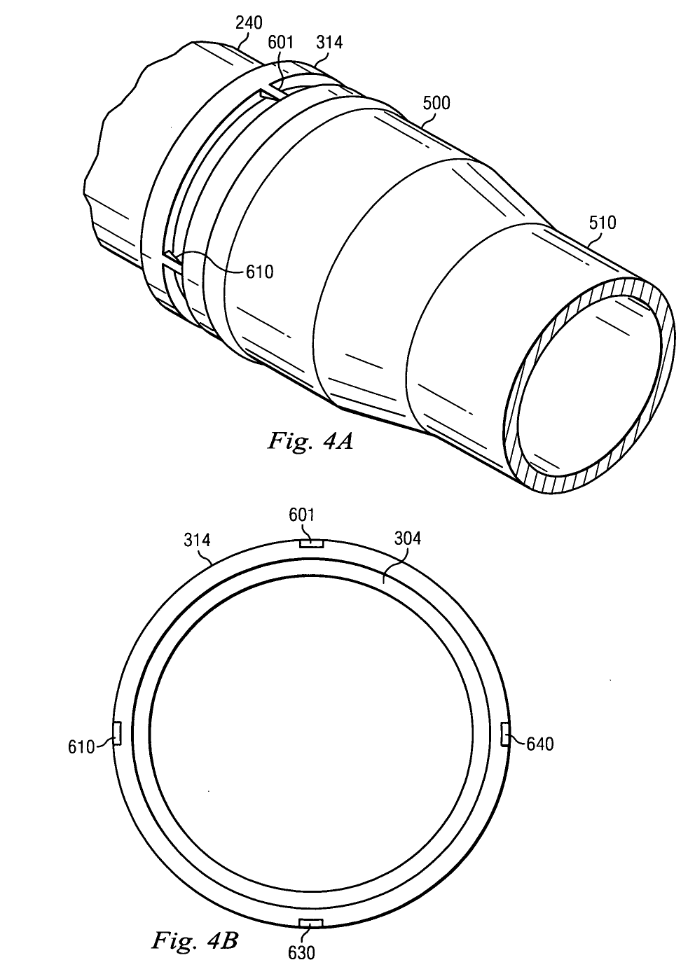

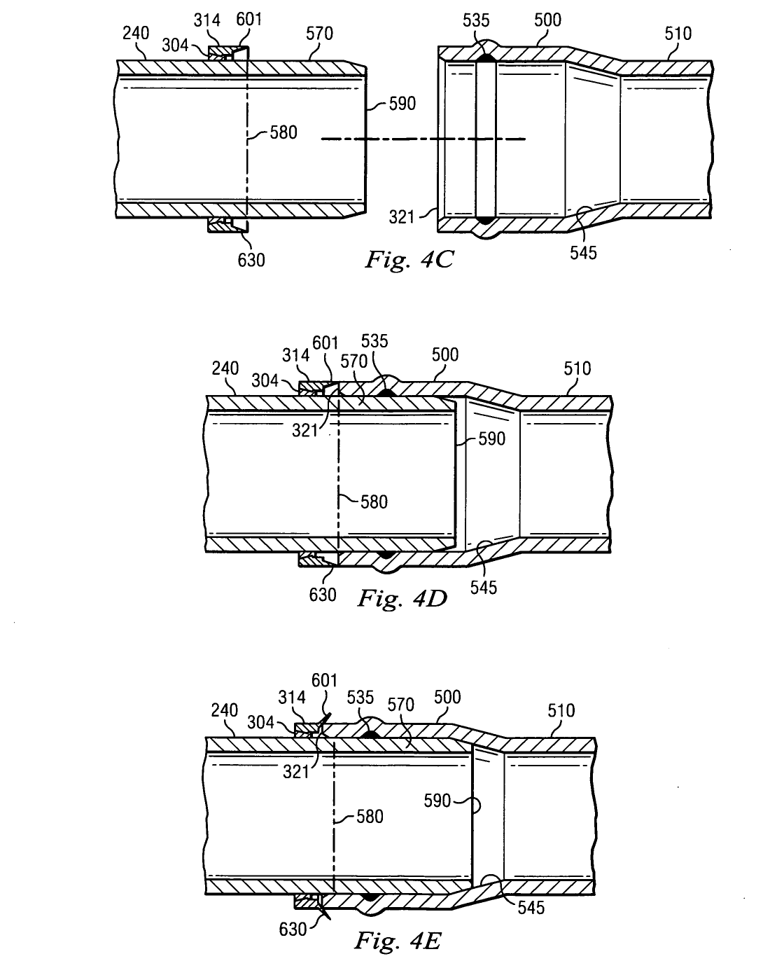

FIG. 4A shows an isometric view of an alternate embodiment having an outer ring 314 and an inner ring 304 attached to a spigot and adjacent a bell. FIG. 4B shows an axial view of the alternate embodiment. Insertion indicators 601, 610, 630 and 640 are shown. The insertion indicators exhibit a “wedge shaped” profile. Insertion indicators 601, 610, 630 and 640 of are preferably formed of natural rubber or silicon. In other embodiments, synthetic rubbers such as, neoprene and polychloroprene may also be used with equal success. In this embodiment four insertion indicators are provided at equal distances around the perimeter of outer ring 314. Of course, those skilled in the art will recognize that a lesser or greater number of insertion indicators would also function.

FIG. 4C is a cross section view of an alternate embodiment in position on spigot 570 and bell 500 prior to insertion. Axial alignment of the pipes is shown.

FIG. 4D shows the alternate embodiment at an optimal insertion position. In an optimal insertion position, bell front lip 321 is in contact with insertion indicators 601, 610, 630 and 640. Also bell front lip 321 and insertion mark 580 are aligned.

FIG. 4E shows a cross section view of a bell and spigot at an over insertion position. Insertion indicators 601 and 630 have flared out as they override bell front lip 321. Bell front lip 321 is in contact with outer ring 314 which prevents further movement. Alternatively, if some but not all of the insertion indicators are deformed, an indication may be derived that spigot 570 was inserted into bell 500 at an undesirable angle.

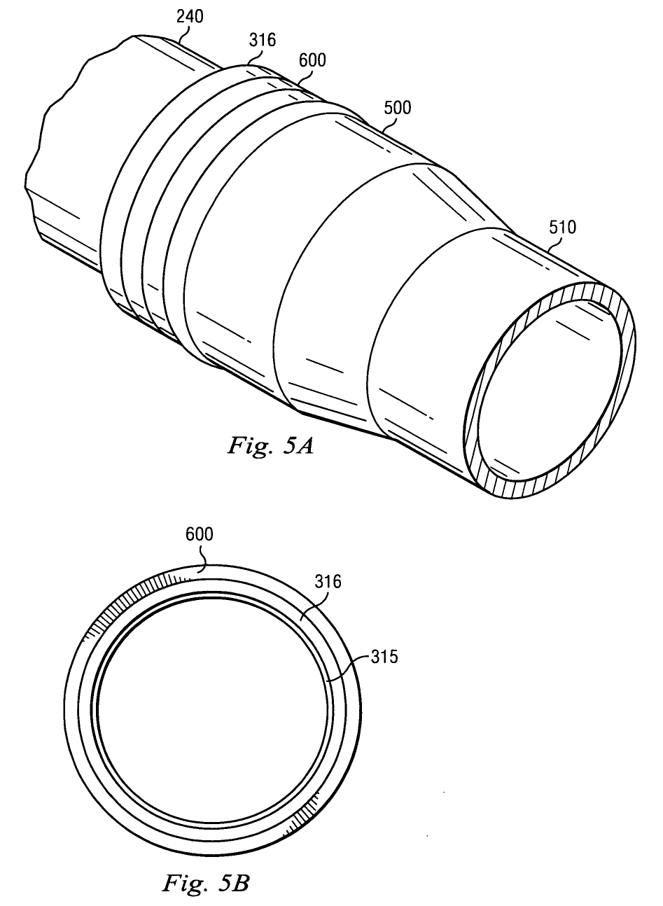

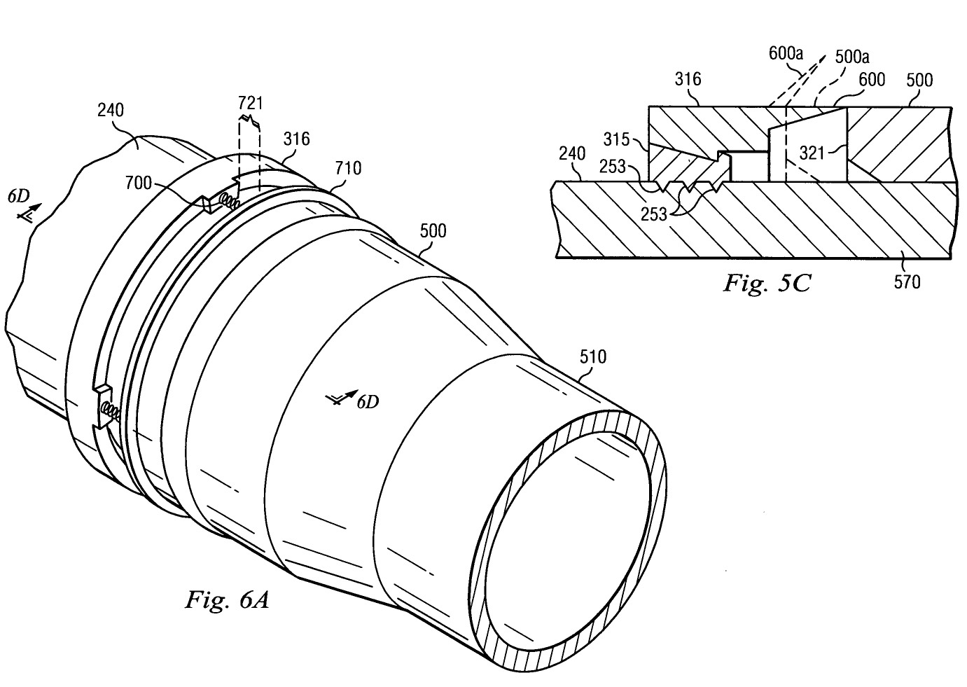

FIG. 5A through 5C show various views of an alternate embodiment. Insertion indicator 600 forms a continuous annular collar with a wedge shaped cross section. Insertion indicator 600 in the preferred embodiment is formed of a natural or synthetic rubber as previously described. Insertion indicator 600 is adhered to outer ring 316 with a suitable epoxy adhesive.

FIG. 5C shows a partial cross section view of the alternate embodiment in use. As spigot 570 advances with respect to bell front lip 321 (shown in position 500a), insertion indicator 600 moves into position 600a flaring out over bell 500. An over insertion condition is indicated by position 600a, which is easily visible upon pipe connection. Maximum travel of bell 500 over spigot 570 is stopped by inner ring 315 and outer ring 316.

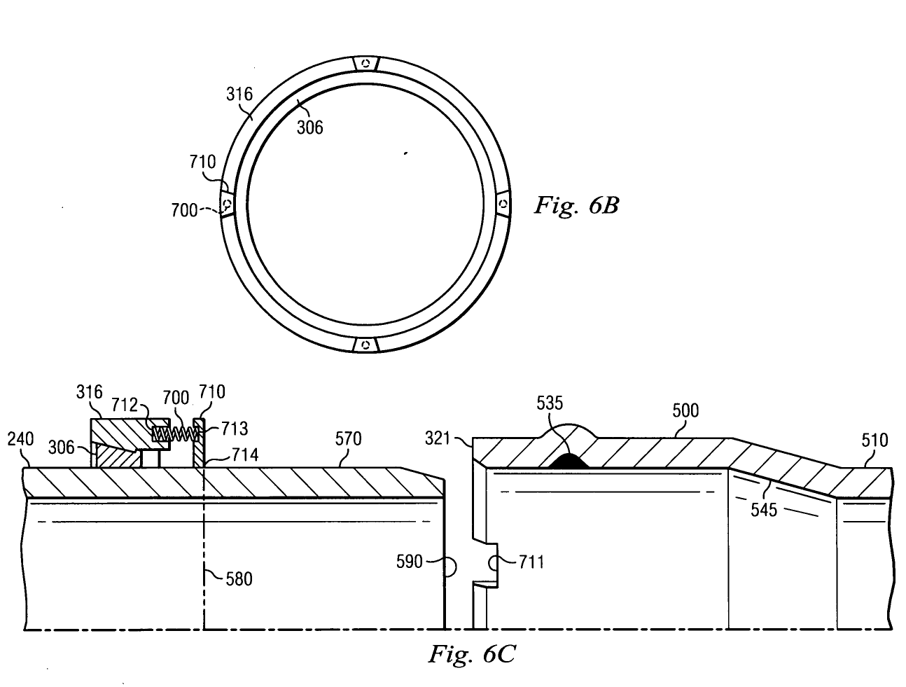

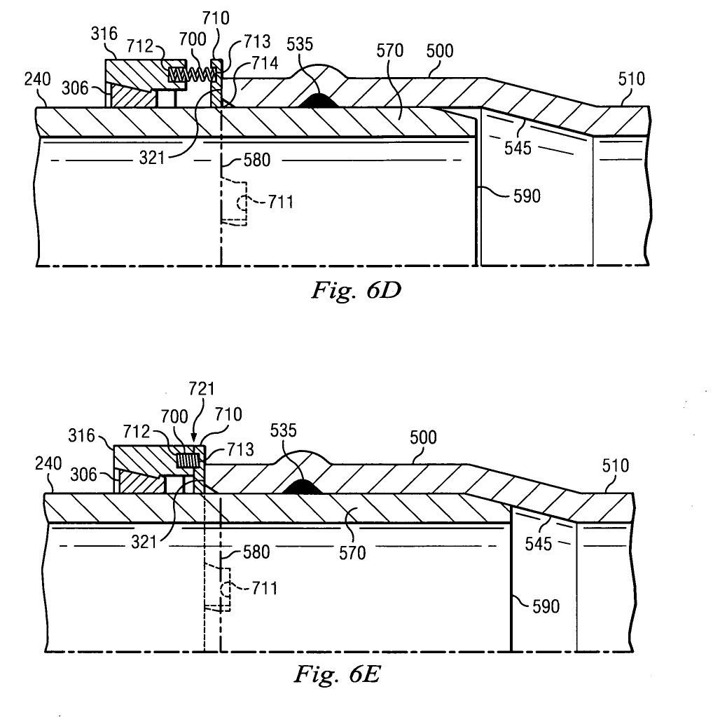

FIGS. 6A through 6E show various views of an alternate embodiment. Ring 710 is a flat annular plate having an inner diameter generally the same as the outer diameter of spigot 570. Ring 710 has holes 713 equally spaced around its outer perimeter. In the preferred embodiment, the holes are approximately half as deep as the width of the ring. In the preferred embodiment the ring is made of ⅛″ plate steel. Outer ring 316 is provided with a plurality of holes 712. Holes 712 are aligned with the axis of the ring and are aligned with holes 713. In each of holes 713 and 712 is a compression spring 700. Each compression spring is preferably spring steel and provides a resistance of approximately 25 pounds per inch of deflection. Compression springs 700 are retained in holes 712 and 713 by a suitable adhesive. Other means of attachment such as spot welding may also be employed. In applications with different diameter pipes a greater or lesser number of springs can be employed. Notch 711 is included for visual inspection of optimal insertion mark 580 circumscribing spigot 570.

FIG. 6C is a cross-section view of the alternate embodiment in position on spigot 570 prior to insertion. FIG. 6D is a cross-section view of a bell and spigot at an optimal insertion position. Bell front lip 321 is in contact with ring 710. Bell front lip 321, ring 710 and insertion mark 580 are aligned. The insertion mark may be viewed through notch 711. Gap 721 provides an indication of insertion depth. In situations when precise insertion is required this gap may be measured by hand.

FIG. 6E shows the alternate embodiment at an over insertion position. As ring 710 is pressed toward spigot 570 compression springs 700 advance into holes 712. An over insertion condition is indicated by observing gap 721. Ring 710 moves out of alignment with insertion mark 580, also indicating an over insertion position. Spigot end 590 is prevented from contacting bell back 545 by bell front lip 321 contacting ring 710, which cannot move past inner ring 306 and outer ring 316.

In this alternate embodiment, compression springs 700 respond to an over insertion position by exerting a force on ring 710. Responding to the force from the compression springs, ring 710 forces bell 500 away from spigot 570 into an optimal insertion position. Visual confirmation of an optimal insertion position is carried out by visual inspection through notch 711 for insertion mark 580. The restoration of spigot 570 and bell 500 into an optimal insertion position provides clearance between spigot end 590 and bell back 545.

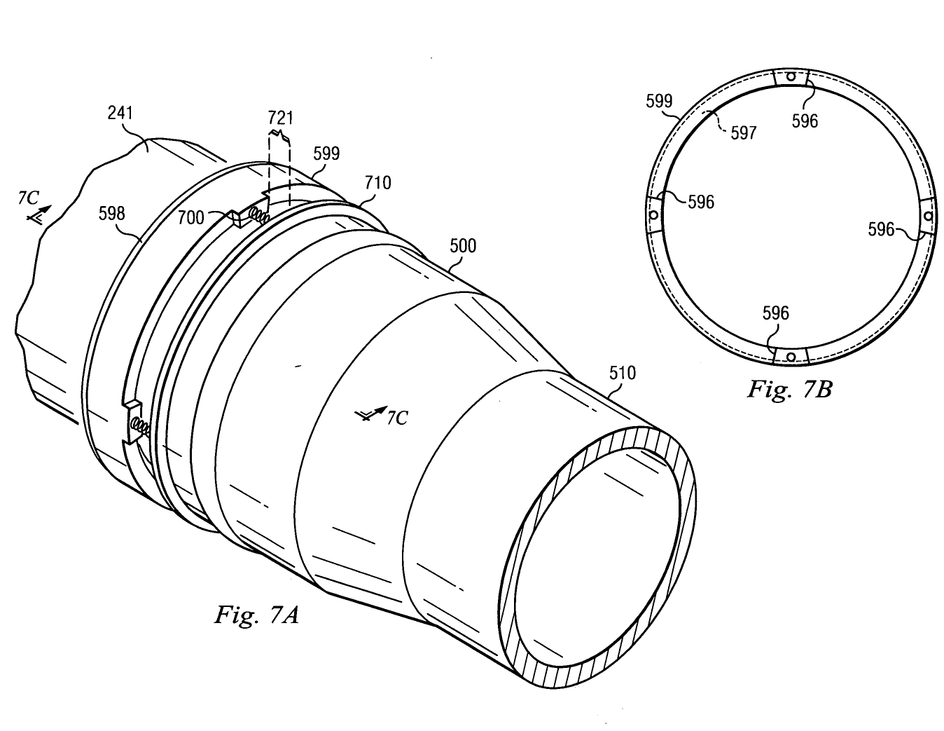

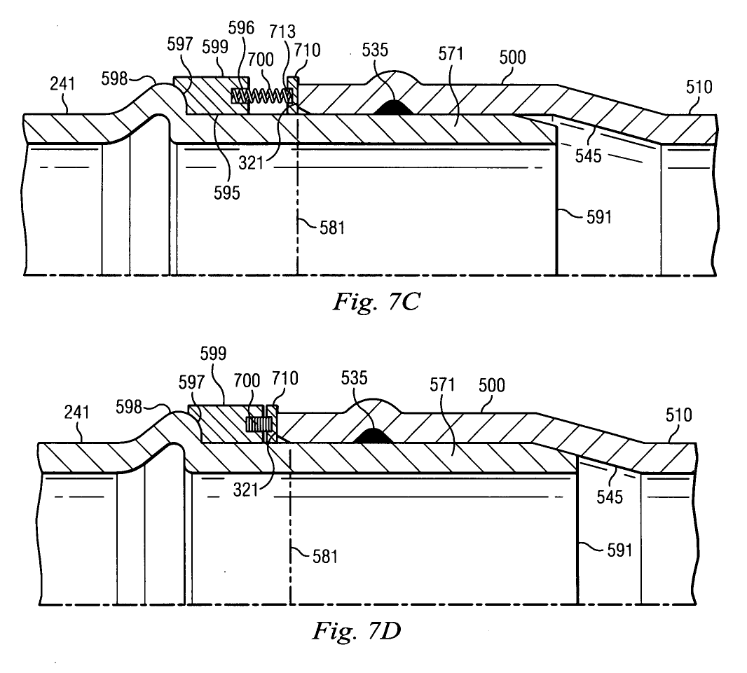

FIGS. 7A through 7D show various views of an alternate embodiment. In this embodiment, spigot pipe includes annular stop 598 integrally formed with spigot pipe 241. Spigot pipe 241 includes a spigot 571 and spigot end 591. Stop ring 599 is an annular steel ring including a plurality of holes 596 and concave surface 597. Concave surface 597 corresponds to the convex shape of annular stop 598. Stop ring 599 also includes inner diameter 595. Inner diameter 595 is generally the same as the outer diameter of spigot pipe 241. Clearance is provided for a sliding fit between the stop ring and the spigot pipe. Stop ring 599 includes a series of holes 596 which are axially aligned with the spigot pipe. Compression springs 700 are provided in each of the plurality of holes 596 and aligned holes 713 in ring 710, as previously described. The compression springs are fixed in the holes with a suitable adhesive or by spot welding. Spigot pipe includes alignment line 581 etched in its surface.

In use, as spigot 571 is advanced toward bell 500, bell 500 contacts ring 710. Ring 710 compresses springs 700 thereby advancing stop ring 599 into annular stop 598. As compression springs 700 are compressed, the gap between stop ring 599 and ring 710 is reduced. Gap 721 provides a visual means of verifying optimal insertion. When compression springs 700 are fully compressed, bell front lip 321, ring 710, stop ring 599 and annular stop 598 are in contact with one another, preventing additional movement of the bell with respect to the spigot. In this embodiment sufficient force is stored in the compression springs in an over insertion position to then push the bell away from the spigot and into an optimal position, when the insertion pressure in removed from the spigot pipe.

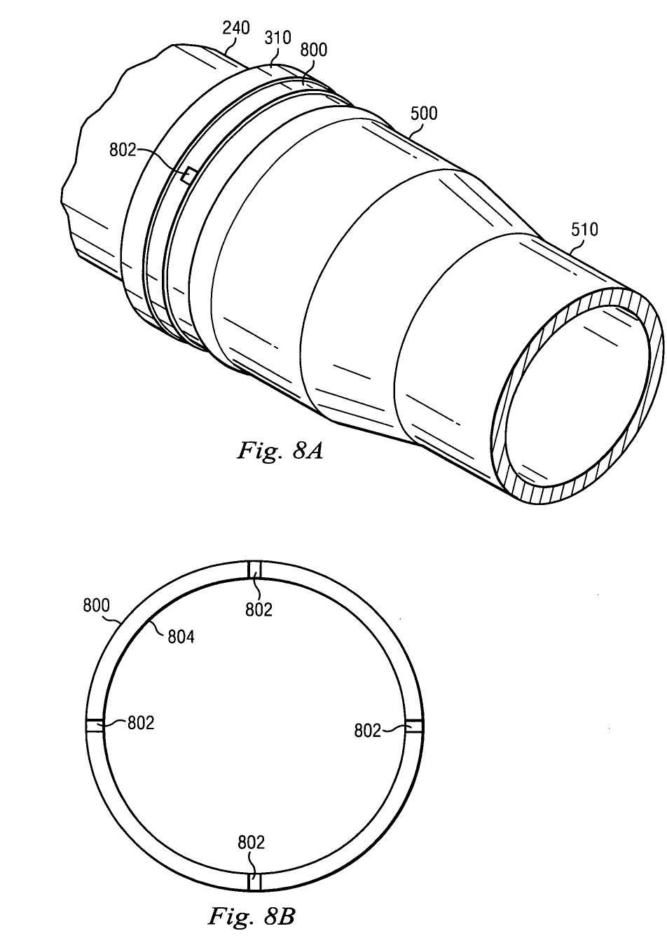

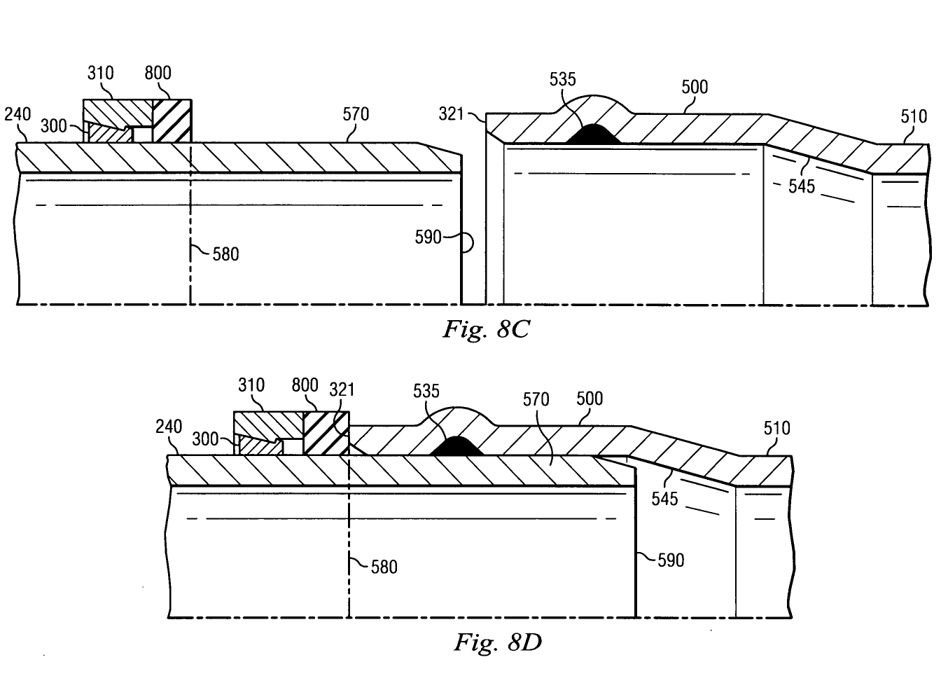

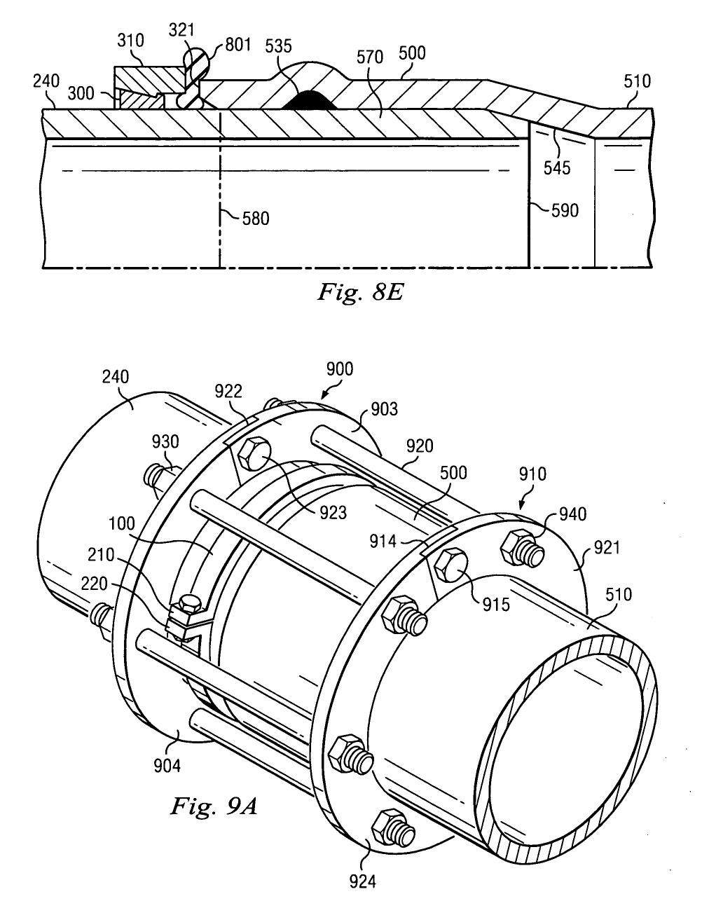

FIG. 8A shows an isometric view of an alternate embodiment. FIG. 8B is an axial view of the alternate embodiment. Elastomeric insertion indicator 800 is positioned adjacent to outer ring 310. Elastomeric insertion indicator 800 forms a continuous annular ring. Inner diameter 804 of elastomeric insertion indicator 800 is slightly larger than the outer diameter of spigot 570. Clearance of 1/16 to ⅛ of an inch is generally preferred. Sighting holes 802 are provided allowing visual inspection of the surface of spigot 570. In the preferred embodiment, elastomeric insertion indicator 800 is comprised of natural rubber or synthetic polyisoprene butyl rubber including polybutadiene. Nitrile rubber and neoprene can also be employed with equal success. Other thermoplastic elastimers, polysulfide rubbers and silicone rubbers may employed with equal success.

FIG. 8C shows the alternate embodiment in position on spigot 570 prior to insertion. Axial alignment of the pipes is indicated.

FIG. 8D shows the alternate embodiment in position on spigot 570 and adjacent bell 500 in an optimal insertion position. As can be seen, bell 500 is in contact with elastomeric insertion indicator 800. Elastomeric insertion indicator 800 is also in contact with outer ring 310. Bell front lip 321 is aligned with insertion mark 580.

FIG. 8E, shows the alternate embodiment in an over insertion position. Bell 500 engages elastomeric insertion indicator 800, compressing it into a deformed position 801. The deformed position serves as an indicator of over insertion. Alternatively, if some portions of elastomeric insertion indicator 800 are more compressed than other portions, insertion at an undesirable angle is indicated. Elastomeric insertion indicator 800 moves out of alignment with insertion mark 580, also indicating an over insertion position.

Spigot end 590, however, is prevented from contacting bell back 545 because bell front lip 321 cannot move past elastomeric insertion indicator 800, which is constrained by outer ring 310. Elastomeric insertion indicator 800 expands to its original dimensions when the pressure on spigot pipe 240 is released. Elastomeric insertion indicator 800 forces spigot 570 and bell 500 back into an optimal insertion position.

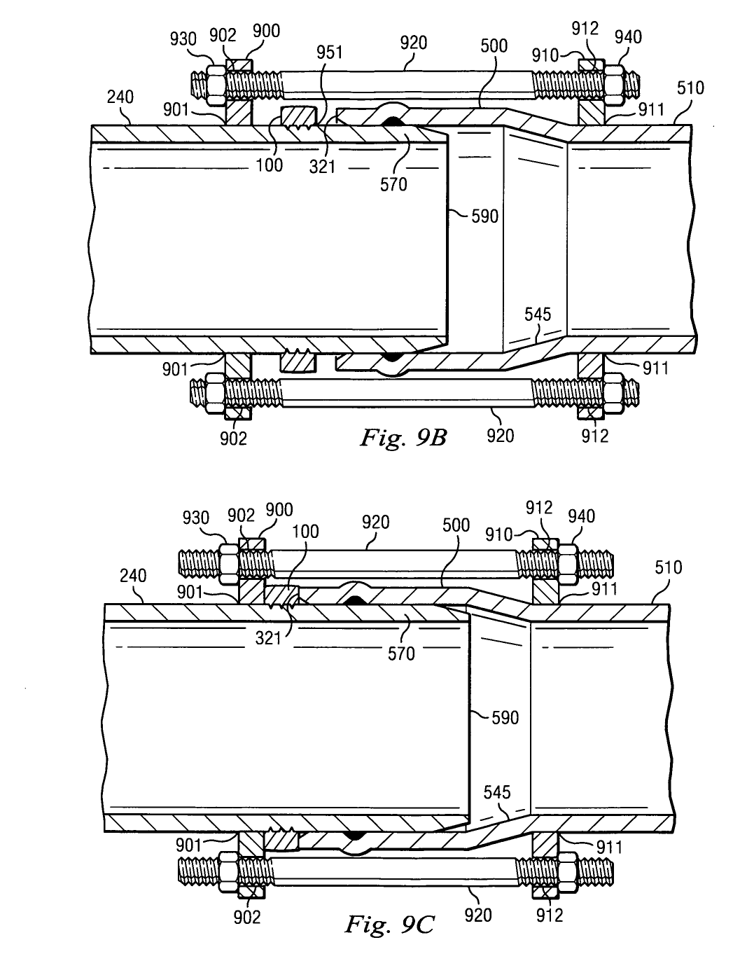

FIGS. 9A through 9C show various views of an alternate embodiment. Spigot flange 900 is comprised of an annular ring having an inside diameter 901. Inside diameter 901 is generally the same diameter as outside diameter of spigot pipe 240 but provides sufficient clearance for a sliding fit. Spigot flange 900 is preferably made of plate steel approximately ¼ inch thick. Spigot flange 900 includes two semi-circular pieces 903 and 904. Stepped joints 922 are provided at opposite sides of the semi-circular pieces to prevent movement between the semi-circular pieces. The stepped joints are joined by bolts 923. Spigot flange 900 includes equally spaced holes 902 through which bolts 920 are passed. Bell flange 910 includes inner diameter 911. Inner diameter 911 is generally the same dimension as outer diameter of pipe 510 but provides clearance for a sliding fit.

Bell flange 910 includes holes 912 which are axially aligned with holes 902. Two semi-circular pieces 921 and 924 make up bell flange 910. The semi-circular pieces are connected by stepped joints 914 and bolts 915.

Pipe clamp 100 (as shown and described with respect to FIGS. 1A and 1B) is positioned adjacent spigot flange 900 and bell 500. Serrations 250 engage the spigot pipe and prevent axial movement of the pipe clamp with respect to the spigot pipe.

Bolts 920 are positioned in holes 902 and 912. Nuts 930 and 940 are secured to bolts 920 adjacent spigot flange 900 and bell flange 910 respectively. Six bolts are provided in the preferred embodiment, spaced 60 degrees apart around the perimeter of the flanges. However, a greater or lesser or number of bolts may be used depending on the diameter of the pipe or the connection strength required for the application as will be understood.

As shown in FIG. 9B, in use, spigot flange 900 is positioned on the exterior surface of spigot pipe 240. Bell flange 910 is positioned adjacent to bell back 545 is a similar manner. Pipe clamp 100 is positioned on the spigot adjacent spigot flange 900. Bolts 920 are positioned in holes 902 and 912 and nuts 930 and 940 are attached. Moving to FIG. 9C, as nuts 930 and 940 are advanced, spigot pipe 240 is drawn into bell 500 until spigot flange 900 is in contact with pipe clamp 100. As seen in this position, pipe clamp 100 is also in contact with bell front lip 321. This is the optimal insertion position.

The embodiment possesses the additional benefit of constraining the pipe insertion within a given range. At maximum joint expansion, spigot nut 930 rests against spigot flange 900 and bell nut 940 rests against bell flange 910. Thus, over-insertion is prevented while a maximum range of motion is preserved.

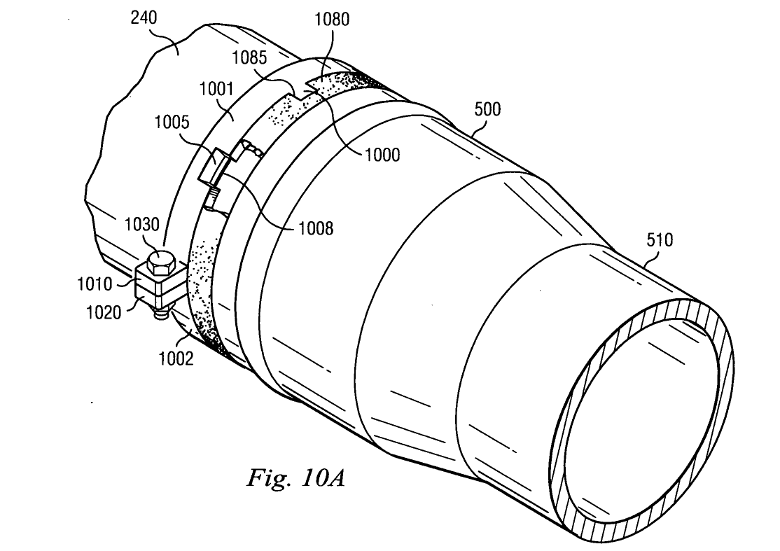

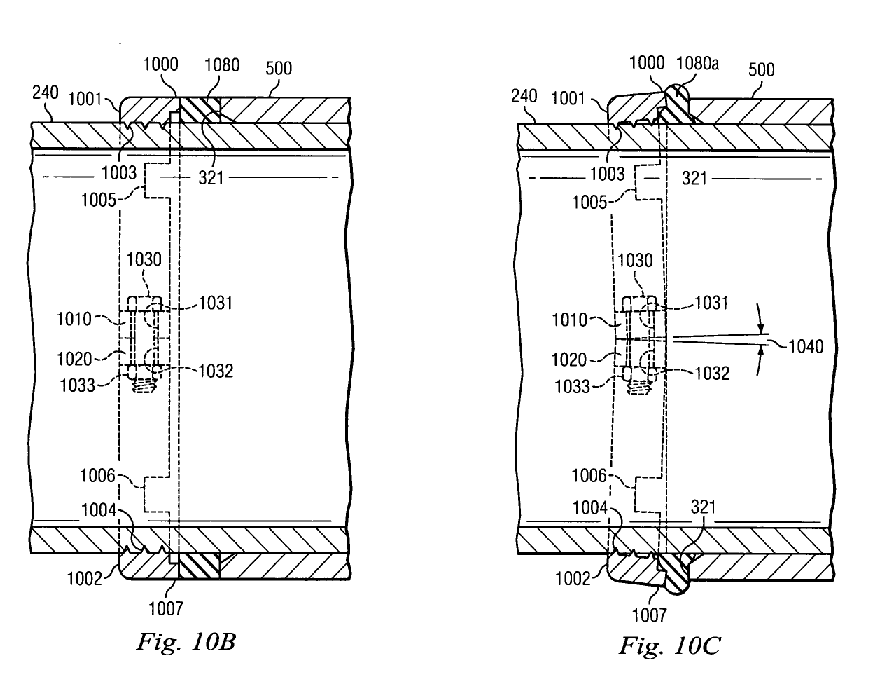

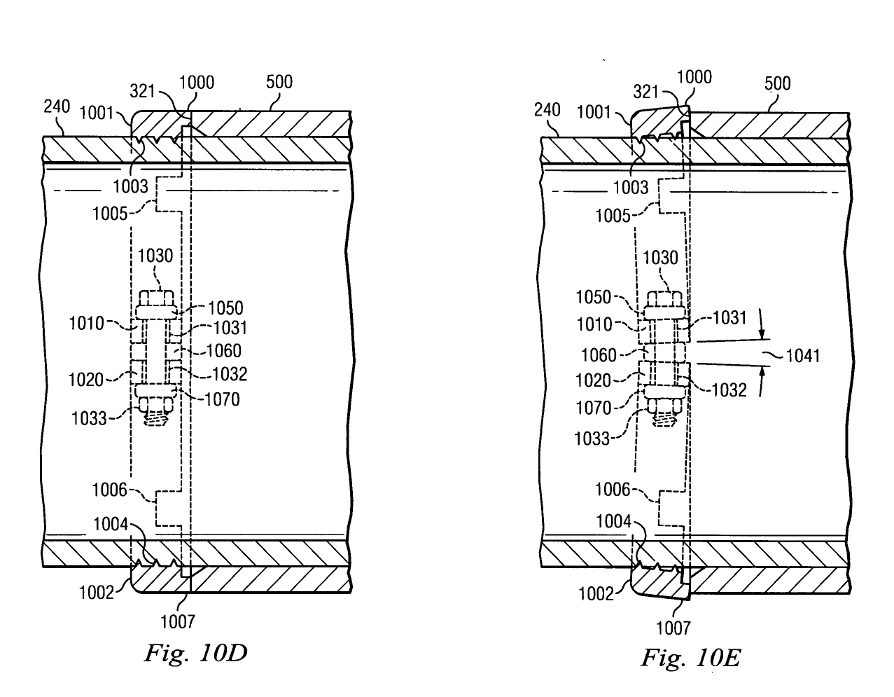

FIG. 10A shows an isometric view of an alternate embodiment. FIGS. 10B and 10C show cross sectional views of the alternate embodiment. Pipe clamp 1001 is comprised of two semi-circular rings surrounding spigot pipe 240. Each of the semi-circular rings includes flanges 1010 and 1020 secured by bolts 1030 and nuts 1033. Bolts 1030 are positioned in holes 1031 and 1032 on each of the pipe clamps 1001 and 1002. Pipe clamps 1001 and 1002 both include teeth 1003 and 1004. Pipe clamps 1001 and 1002 include indicator protrusions 1000 and 1007. Indicator protrusions 1000 and 1007 are positioned adjacent bell 500. In the preferred embodiment, each pipe clamp 1001 and 1002 includes a single indicator protrusion 1000 and 1007. However, in alternate embodiments additional protrusions may be provided. Furthermore, each pipe clamp 1001 and 1002 in the preferred embodiment includes two notches 1005 and 1006 spaced at 90 degree intervals adjacent each indicator protrusion 1000 and 1007, respectively. A scribed line 1008 is included on spigot pipe 240 for alignment purposes.

Elastomeric ring 1080 is positioned adjacent pipe clamp 1001. Elastomeric ring 1080 includes receiving notches 1085 adjacent to and receiving indicator protrusions 1000 and 1007.

As shown best in FIG. 10C, as spigot pipe 240 is inserted into bell 500, bell front lip 321 comes into contact with elastomeric ring 1080. As insertion pressure is increased, the elastomeric ring 1080 deforms into position 1080a. As insertion pressure is increased, indicator protrusions 1000 and 1007 pivot relative to flanges 1010 and 1020. Teeth 1003 and 1004 increase the force applied to the spigot pipe and prevent the pipe clamp from sliding axially along the spigot pipe. The increased insertion pressure results in an angular displacement between flanges 1010 and 1020, causing a gap 1040.

As insertion pressure is decreased the elastomeric ring expands, thereby moving the bell back to the position shown in FIG. 10b from the position shown in FIG. 10c.

Gap 1040 serves as an indicator of over insertion. Scribed line 1008 is placed on spigot pipe 240 to also indicate proper insertion. Notch 1005 allows observation of the scribed line, even when the pipes are over-inserted. The deformating of the resulting ring 1080a also serves as an application of over insertion.

FIGS. 10D and 10E show a cross-section view of an alternate embodiment. Compressible washers 1060 are positioned between flanges 1010 and 1020 adjacent holes 1031 and 1032. Similarly, compressible washers 1050 and 1070 are interspersed between flanges 1010 and 1020 and bolt 1030 and nut 1033, respectively. The composition of the compressible washers in the preferred embodiment is of an elastomeric material as previously described. In another preferred embodiment where insertion pressures are far greater, the elastomeric washers with a lower modulus are preferred such as Teflon®.

In use, as insertion pressure from bell 500 on indicator protrusion 1000 and 1007 increases, pipe clamps 1001 and 1002 are angularly displaced about bolts 1030. Angular gap 1041 is created. Compressible washers 1050, 1060 and 1070 are deformed thereby preventing bending of pipe clamps 1001 and 1002.

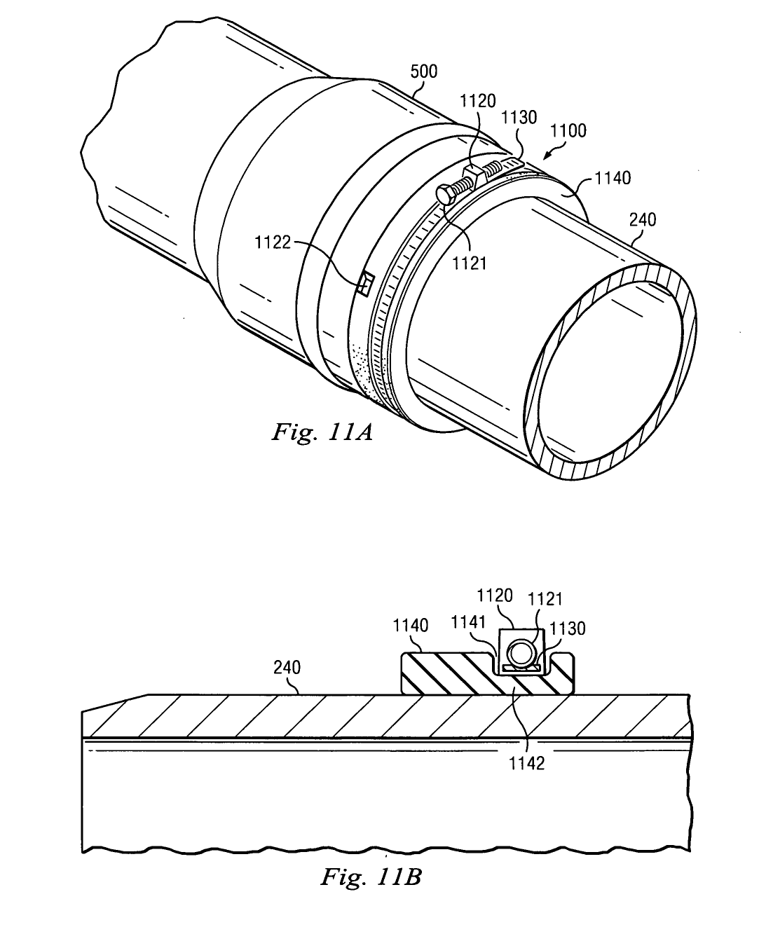

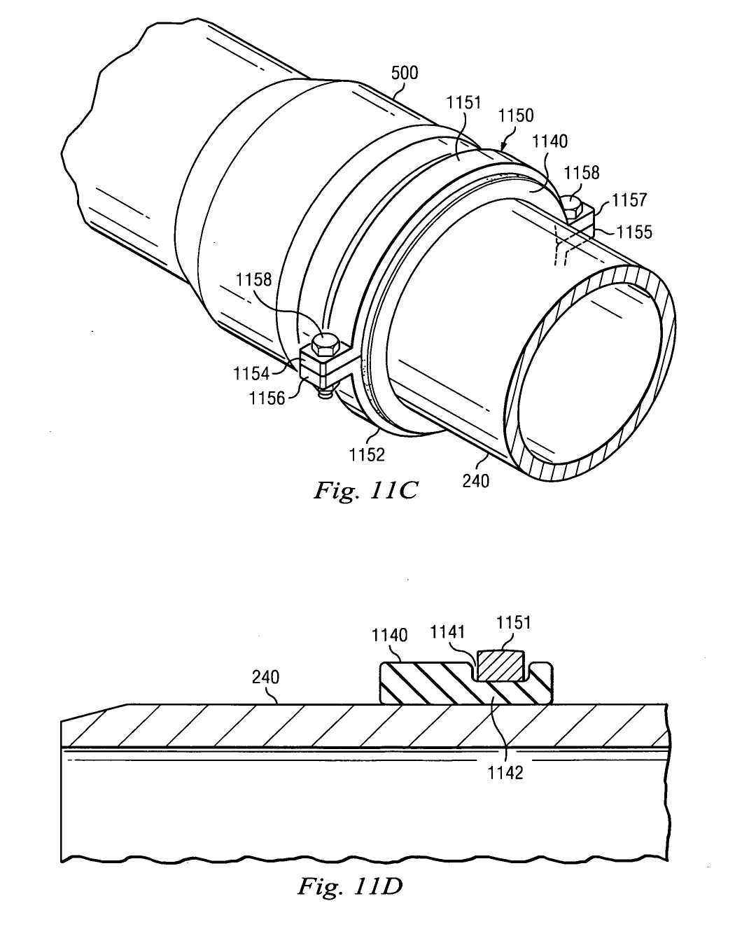

FIGS. 11A and 11B show an isometric view of an alternate embodiment. FIG. 11B shows a partial cross section of the alternate embodiment. Insertion indicator system 1100 consists of an insertion indicator 1140 and band clamp 1130. Insertion indicator 1140 is an annular ring positioned adjacent spigot pipe 240. Insertion indicator 1140 includes annular channel 1141. Insertion indicator 1140 is comprised of an elastomeric or polymeric material as previously described.

Within annular channel 1141 resides band clamp 1130. Band clamp 1130 includes support 1120 and auger 1121. The threads of auger 1121 engage band clamp 1130. Insertion indicator 1140 also includes viewing portal 1122. In the preferred embodiment a single viewing portal is provided; however, in alternate embodiments additional viewing ports may be provided spaced about the perimeter of the insertion indicator. Insertion indicator 1140 has inner diameter 1142. Inner diameter 1142 is slightly larger than the outer diameter of spigot pipe 240. In practice clearance of approximately 1/16 to ⅛ of an inch is preferred.

In use, as auger 1121 is advanced in support 1120, band clamp 1130 is tightened within annular channel 1141, thereby compressing insertion indicator 1140 against the external surface of spigot pipe 240. As bell 500 contacts insertion indicator 1140, an optimal insertion position is indicated. Deformation of the insertion indicator is used to identify an over insertion position. Viewing portal 1122 is used to “site” or observe a marking (not shown) placed on the surface of spigot pipe 240.

FIGS. 11C and 11D show an alternate embodiment. Pipe clamp 1150 includes upper section 1151 and lower section 1152, each having flanges 1154, 1155, 1156 and 1157 respectively, to secure the pipe clamp around the spigot pipe 240 by use of bolts 1158. Pipe clamp 1150 is situated in annular channel 1141.

In use, as bolts 1158 are advanced, pipe clamp 1150 compresses insertion indicator 1140 against the external surface of spigot pipe 240. As bell 500 contacts insertion indicator 1140, an optimal insertion position is indicated. Deformation of the insertion indicator is used to identify an over insertion position period.

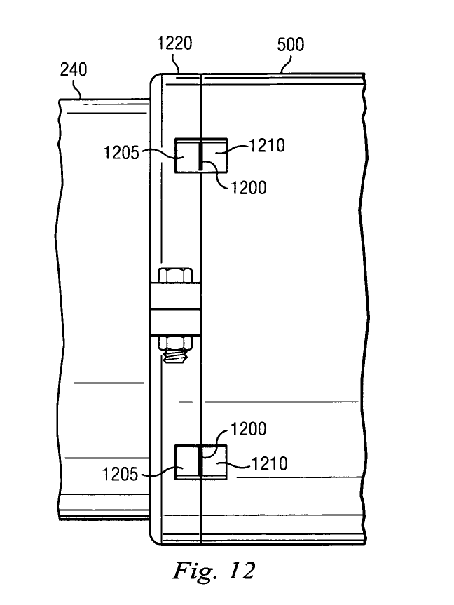

FIG. 12 shows an alternate embodiment. Pipe clamp 1220 includes notches 1205. A circumferential line 1200 is provided on the circumference of spigot pipe 240. Bell 500 includes notch 1210. Notches 1205 and 1210 may be aligned or staggered. In use, circumferential line 1200 is sighted through either or both of notch 1205 and notch 1210 to assist in optimum insertion of the spigot into the bell.

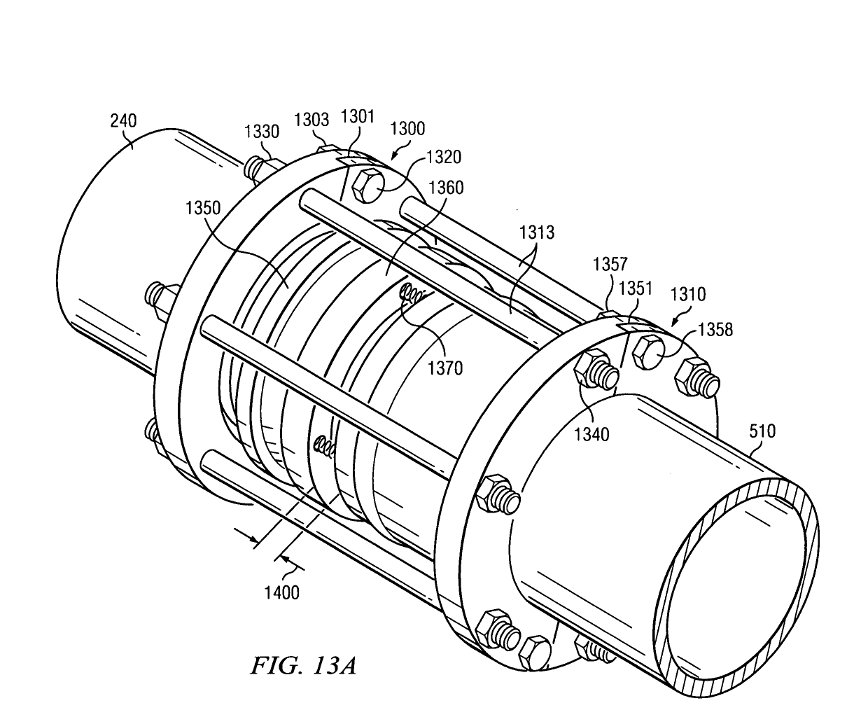

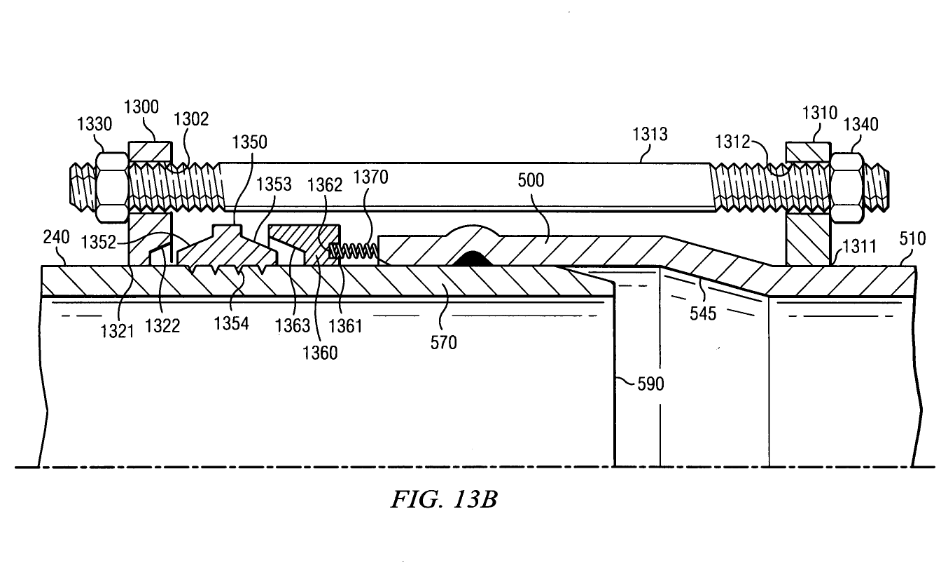

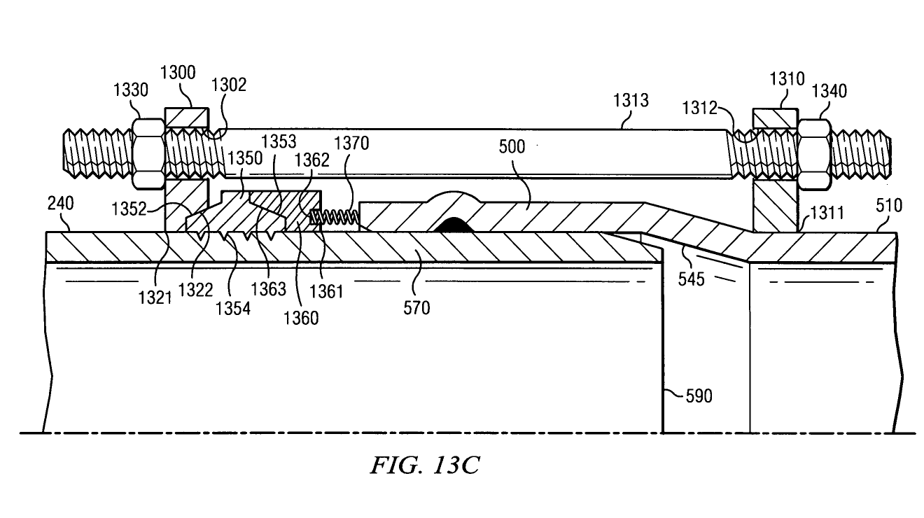

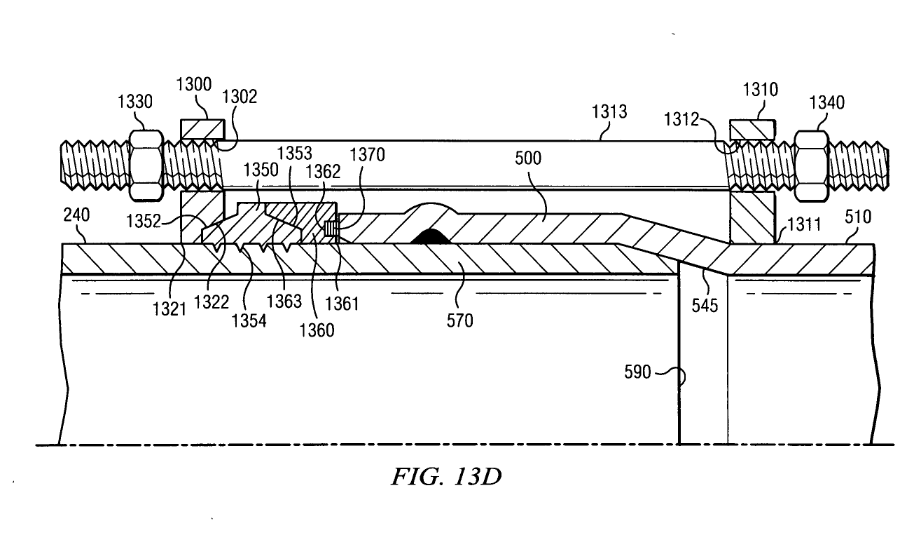

An alternate embodiment is shown in FIGS. 13A through 13D. Spigot flange 1300 is an annular ring having an inner diameter 1321. Inner diameter 1321 is sized slightly larger than the outside diameter of spigot pipe 240 to provide a sliding fit. Spigot flange 1300 includes six holes 1302 spaced at generally 60 degree radial angles. Each hole is axially aligned with spigot pipe. Spigot flange 1300 is provided in two semi-circular pieces, each of the two semi-circular pieces is connected by a set of two joints 1301, spaced 180 degrees apart on the perimeter of spigot flange 1300. Bolts 1320 and nuts 1303 retain joints 1301. Spigot flange 1300 includes annular channel 1322.

Adjacent spigot flange 1300 is locating stop 1350. Locating stop is circular in form and is positioned around spigot 570. Locating stop 1350 includes sloping surfaces 1352 and 1353. Locating stop 1350 also includes serrations 1354. Serrations 1354 are positioned to engage the outer surface of spigot pipe.

Adjacent locating stop 1350 is spring stop 1360. Spring stop 1360 forms a circular ring having an inner diameter 1361 and annular channel 1363. Inner diameter 1361 is sized to provide sufficient clearance to allow sliding movement between spring stop 1360 and spigot pipe. Spring stop 1360 includes a series of holes 1362. Within holes 1362 resides a series of compression springs 1370. Spring stop 1360 is positioned adjacent bell 500. Compression springs 1370 are also adjacent bell 500.

Bell flange 1310 includes inner diameter 1311. Inner diameter 1311 is sized to accommodate pipe 510 with sufficient clearance to allow a sliding movement. Bell flange 1310 is provided in two semi-circular pieces, each of the two semi-circular pieces is connected by a set of two joints 1351, spaced 180 degrees apart on the perimeter of bell flange 1310. Bolts 1358 and nuts 1357 retain joints 1351. Bell flange 1310 includes a series of holes 1312. The holes are axially aligned with the axis of pipe 510. Resident within holes 1312 are bolts 1313. Bolts 1313 are also resident in holes 1302. Bolts 1313 are held in place by nuts 1340 adjacent bell flange 1310 and nuts 1330 adjacent spigot flange 1300.

In use, nuts 1340 and 1330 are advanced on bolts 1313 compressing spigot flange 1300 and bell flange 1310. Spigot flange 1300 and bell flange 1310 slide axially over the surface of spigot pipe 240 and pipe 510. Bell flange 1310 engages bell back 545 thereby forcing bell 500 axially towards spigot pipe 240.

Annular channel 1322 of spigot flange 1300 encounters sloped surface 1352 of locating stop 1350 and comes to rest. Bell 500 compresses compression springs 1370 thereby advancing spring stop 1360 until annular channel 1363 encounters sloped surface 1353 and comes to rest. Visual evaluation of the distance between bell 500 and spring stop 1360, shown as gap 1400, provides an indication of insertion depth.

An over insertion condition is shown best at FIG. 13D. In this position bell 500 is in contact with spring stop 1360. Spring stop 1360 is in contact with locating stop 1350. Locating stop 1350 is in contact with spigot flange 1300. The spring stop, locating stop and spigot flange are locked together by the contact of sloped surface 1352 an annular channel 1322 and by the contact of sloped surface 1353 with annular channel 1363. When pressure is released on spigot pipe 240, compression springs 1370 exert force on bell 500 and spring stop 1360 thereby returning the pipe to an optimal insertion position.

1. An insertion indicator for a bell pipe and spigot pipe connection system, comprising:
a stop ring positioned on the spigot pipe; and,
an indicator means, adjacent the stop ring and the bell pipe, for indicating a proper insertion depth.

2. The insertion indicator of claim 1 wherein the indicator means further comprises:
a brittle indicator post connected to the stop ring, contacting the bell pipe upon the proper insertion depth and shearing away from the stop ring upon an over insertion depth.

3. The insertion indicator of claim 1 wherein the indicator means further comprises:
a flexible annular ring, connected to the stop ring, contacting the bell pipe upon the proper insertion depth and deforming radially upon an over insertion depth.

4. The insertion indicator of claim 1 wherein the spigot pipe and bell pipe are axially aligned and wherein the indicator means further comprises:
a plurality of brittle indicator posts, attached to the stop ring at predetermined radial positions; and,
whereby one of the plurality of brittle indicator posts breaks away from the stop ring when the spigot pipe and the bell pipe become axially misaligned.

5. An insertion indicator for a bell pipe and a spigot pipe connection system comprising:
an annular stop ring fixed to the spigot pipe;
a bell stop ring slidingly engaging the spigot pipe and adjacent the bell pipe;
a resilient member in contact with the annular stop ring and the bell stop ring;
whereby an over insertion condition between the bell pipe and the spigot pipe compresses the resilient member; and,
whereby the resilient member upon decompression returns the bell pipe and the spigot pipe to an optimum position.

6. The insertion indicator of claim 5 wherein the resilient member is a compression spring.

7. The insertion indicator of claim 5 wherein the resilient member is an elastomeric ring.

8. An insertion indicator for a bell pipe and a spigot pipe connection system comprising:
an annular stop ring fixed to the spigot pipe;
an annular resilient ring surrounding the spigot pipe and adjacent the stop ring and the bell pipe;
whereby an over insertion condition between the bell pipe and the spigot pipe compresses the annular resilient ring to a deformation condition; and
whereby the deformation condition forms an indication of over insertion.

9. The insertion indicator of claim 8 whereby the annular resilient ring, upon decompression, returns the bell pipe and the spigot pipe to an optimum position.

10. The insertion indicator of claim 8 wherein the annular resilient ring further comprises an elastomeric material.

11. The insertion indicator of claim 8 wherein the annular resilient ring is further comprised of one of the group of natural rubber and synthetic rubber.

12. An insertion indicator for a bell pipe and a spigot pipe connector system comprising:
a spigot flange adjacent the spigot pipe;
a bell flange adjacent the bell pipe;
a plurality of compression bolts connecting the spigot flange and the bell flange;
a fixed pipe clamp, adjacent to and in engagement with the spigot pipe, for maintaining a position on the spigot pipe; and,
whereby advancing the compression bolts indicates the spigot pipe and the bell pipe in an optimum position and constraints the spigot pipe and the bell pipe to a predetermined range of movement.

13. An insertion indicator for a bell pipe and a spigot pipe connector system comprising:
a first semi-circular stop member at least partially surrounding the spigot pipe and having a first set of connector flanges;
a second semi-circular stop member, at least partially surrounding the spigot pipe and having a second set of connector flanges;
the first semi-circular stop member having at least a first integrally formed positioning spacer;
the second semi-circular stop member having at least a second integrally formed positioning spacer;
at least one of the first set of connector flanges connected to at least one of the second set of connector flanges by at least one connection bolt;
whereby advancing the bell pipe toward the spigot pipe splays the first semi-circular stop member with respect to the second semi-circular stop member and creates an angular gap between the first pair of flanges and the second pair of flanges; and,
whereby the angular gap provides are indication of an over insertion position.

14. The insertion indicator of claim 13 further comprising:
a first plurality of elastomeric washers between the first pair of connecting flanges and
the second pair of connecting flanges; and,
a second plurality of elastomeric washers between the first pair of connecting flanges and the second pair of connecting flanges and the pair of connecting bolts.

15. The insertion indicator of claim 13 further comprising:
a first sighting portal on the first semi-circular stop member;
a second sighting portal on the second semi-circular stop member; and
an indicator line circumscribing the spigot pipe at least partially visible through the first sighting portal and the second sighting portal.

16. An insertion indicator for a bell pipe and a spigot pipe connector system comprising:
a resilient stop ring, having an annular channel, surrounding the spigot pipe and adjacent the bell pipe;
a clamp means, resident in the annular channel, for compressing the resilient stop ring against the spigot pipe; and,
whereby an over insertion condition deforms the resilient stop ring forming an indicator of an over insertion condition.

17. The insertion indicator of claim 16 wherein the spigot pipe further encompasses a circumferential indicator line:
the resilient stop ring further comprises a sighting portal through which at least a portion of the indicator line is visible.

18. An insertion indicator for a bell pipe and a spigot pipe connection system comprising:
a spigot flange slidingly engaged with the spigot pipe;
the spigot flange having a first angled annular channel adjacent the spigot pipe;
a bell flange slidingly engaged with the bell pipe adjacent the bell flare;
a plurality of compression bolts connecting the spigot flange and the bell flange;
a stop ring fixed to the spigot pipe having a first angled annular surface and a second angled annular surface;
an annular spring stop member, adjacent the stop ring, having a second angled annular channel;
a resilient member connecting the annular spring stop member and the bell pipe;
whereby advancing the compression bolts compresses the resilient member, engages the second annular channel with the second annular surface; and
engages the first annular channel with the first annular surface;
thereby flexibly locking the spigot flange and the spring stop to the stop ring;
whereby the bell pipe is resiliently locked onto the spigot pipe; and,
whereby an indicator distance between the bell pipe and the spring stop provides an indicator of an optimum insertion position.

19. The insertion indicator of claim 18 wherein the spigot flange is further comprised of:
a first semi-circular piece and a second semi-circular piece; and
wherein the first semi-circular piece is connected to the second semi-circular piece with at least one step joint.

20. A method for determining an over insertion position between a bell pipe and a spigot pipe in a bell and spigot connection system comprising the steps of:
providing an indicator means, adjacent a stop ring and the bell pipe, for indicating an over insertion depth; and
observing a displacement of the indicator means upon connection of the spigot pipe to the bell pipe.

21. The method of claim 20 wherein the step of observing further comprises observing a radial deformation of the indicator means.

22. The method of claim 20 wherein the step of observing further comprises observing an axial movement of the indicator means.

23. The method of claim 20 wherein the step of observing further comprises observing a reference mark fixed to the spigot pipe relative to the indicator means.

24. The method of claim 20 wherein the step of observing further comprises observing a tab detached from the stop ring.

25. A pipe stop for a bell pipe and spigot pipe connection system comprising:
a first semi-circular stop member at least partially surrounding the spigot pipe and having a first connector flange;
a second semi-circular stop member, at least partially surrounding the spigot pipe and having a second connector flange;
the first connector flange connected to the second connector flange by a connection bolt;
the first semi-circular stop member including a first set of annular serrations adjacent the spigot pipe;
the second semi-circular stop member including a second set of annular serrations adjacent the spigot pipe;
whereby advancing the connection bolt drives the serrations into the spigot pipe; and,
whereby over insertion of the spigot pipe into the bell pipe is prevented by contact of the first semi-circular stop member and the second semi-circular stop member with the bell pipe.

26. A pipe clamp stop for a bell pipe and spigot pipe connection system comprising:
a circular outer ring having an annular beveled surface and an annular reverse stop surface;
a circular inner ring, adjacent the bell pipe, including a set of serrations engaging the bell pipe;
the circular inner ring including an expansion gap;
the circular inner ring further including a mating annular beveled surface engaging the annular beveled surface and an mating annular reverse stop surface engaging the annular reverse stop surface; and,
whereby as the bell pipe is advanced on the spigot pipe, the bell pipe engages the outer ring and contracts the inner ring to form a pipe stop.

27. An insertion indicator for a bell pipe and a spigot pipe connection system comprising:
A pipe clamp means, fixed to the spigot pipe, for locating the bell pipe on the spigot pipe;
A resilient ring, adjacent the pipe clamp means and the bell pipe;
Whereby over insertion of the spigot pipe into the bell pipe places the resilient ring in a compressed position; and whereby the resilient ring when in the compressed position responds by expanding and moving the bell pipe away from the spigot pipe to an optimum insertion position.

28. The insertion indicator of claim 27 wherein the pipe clamp means further comprises a notch for viewing an indicator line and the spigot pipe

29. The insertion indicator of claim 27 wherein the pipe clamp means further comprises a plurality of semi-circular pipe clamps engaged by a set of bolts.

30. The insertion indicator of claim 27 whereby the pipe clamp means further comprises an indicator protrusion; and the resilient ring further comprises a receiving notch engaging the indictor protrusion.
